(19) United States
(12) Patent Application Publication
(10) Pub. No.: US 2026/0129600 A1
(43) Pub. Date: May 7, 2026

(54) METHOD AND APPARATUS FOR COMMUNICATING UE INFORMATION IN NTN

(71) Applicant: Samsung Electronics Co., Ltd., Suwon-si, Gyeonggi-do (KR)

(72) Inventors: Mahmoud WATFA, Staines (GB); Chadi KHIRALLAH, Staines (GB); David GUTIERREZ ESTEVEZ, Staines (GB)

(21) Appl. No.: 18/703,897

(22) PCT Filed: Oct. 25, 2022
(86) PCT No.: PCT/KR2022/016327

§ 371 Date: Apr. 23, 2024

(30) Foreign Application Priority Data
Oct. 25, 2021 (GB) 2115348.1
Jan. 27, 2022 (GB) 2201046.6
Oct. 18, 2022 (GB) 2215373.8

(51) Int. Cl. H04W 64/00; H04W 8/20; H04W 12/02

(52) U.S. Cl. CPC H04W 64/00; H04W 8/20; H04W 12/02

(57) ABSTRACT

The disclosure relates to a 5G or 6G communication system for supporting a higher data transmission rate. A method for receiving information from a user equipment (UE) by a network device in a non-terrestrial network (NTN) is provided. The method comprise identifying whether user consent for requesting location information of the UE is required; based on identifying that the user consent is required, identifying whether the user consent exists; based on identifying that the user consent exists, transmitting a request for the location information of the UE, to the UE; and receiving the location information of the UE from the UE in response to the request.

### CROSS-REFERENCE TO RELATED APPLICATION(S)

This application is a U.S. National Stage application under 35 U.S.C. § 371 of an International application number PCT/KR2022/016327, filed on Oct. 25, 2022, which is based on and claims the benefit of a Great Britain application number 2115348.1, filed on Oct. 25, 2021, in the Great Britain Intellectual Property Office, and of a Great Britain application number 2201046.6, filed on Jan. 27, 2022, in the Great Britain Intellectual Property Office, and of Great Britain application number 2215373.8 filed on Oct. 18, 2022, in the Great Britain Intellectual Property Office, the disclosure of each of which is incorporated by reference herein in its entirety.

### TECHNICAL FIELD

The present invention relates to a satellite access for 5GC (5th generation communication).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### Brief Background on Satellite Access for 5GC

3GPP (3rd generation partnership project) is developing solutions for the use of satellite access for connecting UEs (user equipments) to the 5G (5th generation) core network. Selection of a PLMN (public land mobile network) while using satellite access is a key component of the feature and it is described in TS 24.821 V17.0.0 [1].

FIG. 1 shows one of the deployment options as described in [1]. FIG. 1 shows that a satellite coverage can actually span beyond a particular country for which it is intended (e.g. Country A) such that the coverage may unintentionally spread to other countries such as B and C as shown in FIG. 1.

### Brief Background on Initial NAS Message Protection

The 5GS enables the protection of initial NAS messages by avoiding the transmission of sensitive information elements (IEs) that are not ciphered. Some details of the initial NAS message protection are provided below from section 4.4.6 of TS 24.501 V17.4.1 [2]:

### 4.4.6 Protection of Initial NAS Signaling Messages

The 5GS supports protection of initial NAS messages as specified in 3GPP TS 33.501 [24]. The protection of initial NAS messages applies to the REGISTRATION REQUEST, SERVICE REQUEST and CONTROL PLANE SERVICE REQUEST message, and is achieved as follows:
a) If the UE does not have a valid 5G NAS security context, the UE sends a REGISTRATION REQUEST message including cleartext IEs only. After activating a 5G NAS security context resulting from a security mode control procedure:
1) if the UE needs to send non-cleartext IEs, the UE shall include the entire REGISTRATION REQUEST message (i.e. containing both cleartext IEs and non-cleartext IEs) in the NAS message container IE and shall include the NAS message container IE in the SECURITY MODE COMPLETE message; or
2) if the UE does not need to send non-cleartext IEs, the UE shall include the entire REGISTRATION REQUEST message (i.e. containing cleartext IEs only) in the NAS message container IE and shall include the NAS message container IE in the SECURITY MODE COMPLETE message.
b) If the UE has a valid 5G NAS security context and:
1) the UE needs to send non-cleartext IEs in a REGISTRATION REQUEST or SERVICE REQUEST message, the UE includes the entire REGISTRATION REQUEST or SERVICE REQUEST message (i.e. containing both cleartext IEs and non-cleartext IEs) in the NAS message container IE and shall cipher the value part of the NAS message container IE. The UE shall then send a REGISTRATION REQUEST or SERVICE REQUEST message containing the cleartext IEs and the NAS message container IE;
2) the UE needs to send non-cleartext IEs in a CONTROL PLANE SERVICE REQUEST message:
i) if CIoT small data container IE is the only non-cleartext IE to be sent, the UE shall cipher the value part of the CIoT small data container IE. The UE shall then send a CONTROL PLANE SERVICE REQUEST message containing the cleartext IEs and the CIoT small data container IE;
ii) otherwise, the UE includes non-cleartext IEs in the NAS message container IE and shall cipher the value part of the NAS message container IE. The UE shall then send a CONTROL PLANE SERVICE REQUEST message containing the cleartext IEs and the NAS message container IE; or
3) the UE does not need to send non-cleartext IEs in a REGISTRATION REQUEST or SERVICE REQUEST or CONTROL PLANE SERVICE REQUEST message, the UE sends the REGISTRATION REQUEST or SERVICE REQUEST or CONTROL PLANE SERVICE REQUEST message without including the NAS message container IE.

When the initial NAS message is a REGISTRATION REQUEST message, the cleartext IEs are:
Extended protocol discriminator;
Security header type;
Spare half octet;
Registration request message identity;
5GS registration type;
ngKSI;
5GS mobile identity;
UE security capability;
Additional GUTI;
UE status;
EPS NAS message container; and
NID.

When the initial NAS message is a SERVICE REQUEST message, the cleartext IEs are:
Extended protocol discriminator;
Security header type;
Spare half octet;
ngKSI;
Service request message identity;
Service type; and
5G-S-TMSI.

When the initial NAS message is a CONTROL PLANE SERVICE REQUEST message, the cleartext IEs are:
Extended protocol discriminator;
Security header type;
Spare half octet;
ngKSI;
Control plane service request message identity; and
Control plane service type.

When the UE sends a REGISTRATION REQUEST or SERVICE REQUEST or CONTROL PLANE SERVICE REQUEST message that includes a NAS message container IE, the UE shall set the security header type of the initial NAS message to “integrity protected”.

When the AMF receives an integrity protected initial NAS message which includes a NAS message container IE, the AMF shall decipher the value part of the NAS message container IE. If the received initial NAS message is a REGISTRATION REQUEST message or a SERVICE REQUEST message, the AMF shall consider the NAS message that is obtained from the NAS message container IE as the initial NAS message that triggered the procedure.

When the AMF receives a CONTROL PLANE SERVICE REQUEST message which includes a CIoT small data container IE, the AMF shall decipher the value part of the CIoT small data container IE and handle the message as specified in subclause 5.6.1.4.2.

When the initial NAS message is a DEREGISTRATION REQUEST message, the UE always sends the NAS message unciphered.

If the UE:
a) has 5G-EA0 as a selected 5G NAS security algorithm; and
b) selects a PLMN other than Registered PLMN and EPLMN;
the UE shall delete the 5G NAS security context and send an initial NAS message including cleartext IEs only as described in this subclause for the case when the UE does not have a valid 5G NAS security context.

NOTE: UE deletes the 5G NAS security context only if the UE is not in the connected mode.

### DISCLOSURE OF INVENTION

### Technical Problem

Hence, there is a need to handle cases in which satellite coverage spans beyond a particular country for which it is intended.

### Solution to Problem

According to an embodiment of the present disclosure, a method for receiving information from a user equipment (UE) by a network device in a non-terrestrial network (NTN) is provided. The method comprise identifying whether user consent for requesting location information of the UE is required; based on identifying that the user consent is required, identifying whether the user consent exists; based on identifying that the user consent exists, transmitting a request for the location information of the UE, to the UE; and receiving the location information of the UE from the UE in response to the request.

According to an embodiment of the present disclosure, a method for transmitting information by a user equipment (UE) in a non-terrestrial network (NTN) is provided. the method comprises subscribing to the NTN with subscription information including user consent for requesting location information of the UE; receiving a request for the location information of the UE from a network device; and transmitting the location information of the UE to the network device, in response to the request.

According to an embodiment of the present disclosure, a network device for receiving information from a user equipment (UE) in a non-terrestrial network (NTN) is provided. The network comprises a transceiver; and a controller coupled to the transceiver. The controller is configured to identify whether user consent for requesting location information of the UE is required; based on identifying that the user consent is required, identify whether the user consent exists; based on identifying that the user consent exists, transmit a request for the location information of the UE, to the UE; and receive the location information of the UE from the UE in response to the request

According to an embodiment of the present disclosure, a user equipment (UE) for transmitting information in a non-terrestrial network (NTN) is provided. The UE comprises a transceiver; and a controller coupled to the transceiver. The controller is configured to subscribe to the NTN with subscription information including user consent for requesting location information of the UE; receive a request for the location information of the UE from a network device; and transmit the location information of the UE to the network device, in response to the request.

An aspect provides a method of sending User Equipment, UE, information in and/or to a network, the method comprising:
sending, by a UE, UE Location Information, ULI, thereof, preferably directly, to the network, for example to an Access and Mobility Management Function, AMF, or Mobility Management Entity, MME, thereof, using signaling, for example Non-Access Stratum, NAS, signaling such as a NAS message, comprising protecting the signaling using a security context, for example an existing security context such as an existing security context of the UE; and/or
optionally, sending by the UE to the network, user consent and/or a Tracking Area Code, TAC, for example a detected TAC and/or a selected TAC.

In one example, the security context is an activated and/or in use security context and/or wherein the security context is an existing context of the UE, for example from a previous registration thereof.

In one example, the method comprises:
performing, by the UE, initial registration, for example with the network such as by comprising sending, by the UE to the network, a Registration Request, wherein the UE does not have an existing security context; and
sending, by the UE to the network, the ULI thereof using messaging, for example in a Security Mode Complete message, using ciphering and/or integrity protection.

In one example, the method comprises:
performing, by the UE, initial registration, for example with the network such as by comprising sending, by the UE to the network, a Registration Request, wherein the UE does have an existing security context, for example a valid 5G NAS security context; and
sending, by the UE to the network, the ULI thereof in a new Information Element, IE.

In one example, the IE is part of a Registration Request message included in a NAS message container IE and/or wherein the new IE is included in a NAS message container IE separate from the Registration Request message.

In one example, the method comprises sending, by the UE to the network, a Registration Request and indicating, by the UE, that a message includes the ULI.

In one example, the method comprises receiving, by the network, for example an Access and Mobility Management Function, AMF, or Mobility Management Entity, MME, thereof, the ULI and/or optionally user consent and/or a Tracking Area Code, TAC, for example a detected TAC and/or a selected TAC.

In one example, the method comprises verifying, by the network, use of the ULI.

In one example, the method comprises determining, by the network, for example an Access and Mobility Management Function, AMF, or Mobility Management Entity, MME, thereof, a current location and/or country of the UE.

In one example, the method comprises forwarding the ULI and/or consent or rejecting a request from the UE, based on a result of the determining.

An aspect provides a method of using User Equipment, UE, information by a network, the method comprising:
receiving, by the network from a UE, for example an Access and Mobility Management Function, AMF, or Mobility Management Entity, MME, of the network, UE Location Information, ULI of the UE, via signaling, for example Non-Access Stratum, NAS, signaling such as a NAS message, comprising protecting the signaling using a security context, for example an existing security context such as an existing security context of the UE;
optionally, receiving by the network to the UE, user consent and/or a Tracking Area Code, TAC, for example a detected TAC and/or a selected TAC; and
verifying, by the network, use or request of the ULI.

In one example, verifying, by the network, use of the ULI is based on subscription information, for example wherein the subscription information indicates one or more of: use of ULI is required or is optional, optionally based on a country in question; a PLMN wherein user consent is required for NTN, wherein the user consent requirement is met via provisional means.

In one example, verifying, by the network, use or request of the ULI is based on subscription information, for example wherein the subscription information indicates one or more of: use of ULI is required or is optional, optionally based on a country in question; request of ULI is required or is optional, by the network, optionally based on a country in question; a PLMN wherein user consent is required for NTN, wherein the user consent requirement is met via provisional means. For example, the network would request UE location to use the UE location, if there is a user consent available (based on subscription, etc.) .

In one example, the method comprises determining, by the network, for example an Access and Mobility Management Function, AMF, or Mobility Management Entity, MME, thereof, a current location and/or country of the UE.

In one example, the method comprises forwarding the ULI and/or consent or rejecting a request from the UE, based on a result of the determining.

In one example, the method comprises providing, by the network for example an Access and Mobility Management Function, AMF, or Mobility Management Entity, MME, thereof, the user consent to other network entities, for example a RAN node, wherein the user consent on the use or request of the ULI is obtained from the UE, on subscription information and/or met via provisional means.

In one example, the method comprises providing, by the network for example an Access and Mobility Management Function, AMF, or Mobility Management Entity, MME, thereof, the user consent to other network entities, for example a RAN node, wherein the user consent on the use or request of the ULI is after access stratum, AS, security.

### BRIEF DESCRIPTION OF DRAWINGS

For a better understanding of the invention, and to show how exemplary embodiments of the same may be brought into effect, reference will be made, by way of example only, to the accompanying diagrammatic Figures, in which:

FIG. 1 schematically depicts an example deployment option (referred to as scenario A in TS 24.821 V 17.0.0);

FIG. 2 schematically depicts an example in which a UE in country B wrongly assumes it is located in Country A;

FIG. 3 schematically depicts a method according to an exemplary embodiment; and

FIG. 4 schematically depicts a method according to an exemplary embodiment.

FIG. 5 schematically depicts a method of a network device according to an exemplary embodiment.

FIG. 6 schematically depicts a method of a UE according to an exemplary embodiment.

FIG. 7 schematically depicts a block diagram of a device according to an exemplary embodiment.

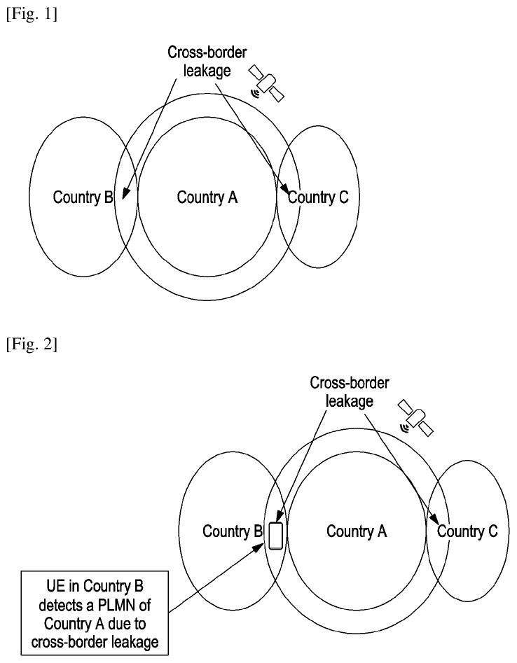

### MODE FOR THE INVENTION

According to the present invention there is provided a method, as set forth in the appended claims. Also provided is a network. Other features of the invention will be apparent from the dependent claims, and the description that follows.

The following problem has been identified by the inventors.

Assume the satellite coverage “leaks” into neighboring countries where a UE in a Country B receives/detects “leaked” coverage from a satellite that is providing coverage for Country A as shown in FIG. 2. In this case, the UE will wrongly assume that it is in Country A since the PLMN ID (say e.g. PLMN A) that is detected by the UE (from the broadcast information of the cross-border leakage) will contain a Mobile Country Code (MCC) pointing to Country A.

Therefore, the detection of this cross-border leakage leads to a wrong PLMN selection of a UE i.e. the UE selects PLMN A (since it is detected) as opposed to the PLMN(s) within Country B where the UE is actually located.

In summary, the cross-border leakage creates cases in which the UE wrongly assumes to be in one location/country whereas the UE is actually in a different location/country. Consequently, when the RAN (which is now using a satellite access) selects an AMF in order to send the UE's (initial) NAS message, the RAN would select an AMF based on the PLMN ID that the UE has selected which in turn is a wrong PLMN ID. As such, the UE's NAS message (e.g. Registration Request) may be rejected by the AMF if the latter determines a mismatch with respect to the UE's location relative to the network itself.

One of the related problems, which is what this document strives to solve, is regarding how the AMF comes to know the true location of the UE. The main solution assumption that has been discussed so far in 3GPP is one in which the UE provides an estimate of its location to the RAN node and then the RAN node forwards this location information to the AMF. The AMF then verifies if the UE is actually in the country for which the selected PLMN is meant to serve. The key problem with this solution assumption is that the location information will be sent in the clear i.e. without any security protection. This is because the UE is performing an initial registration without any previous security context that is shared with the selected PLMN. As such, in the process of sending the UE's location information to the RAN, any rogue entity can acquire this information which is considered to be violating the user's privacy and/or confidentiality. Moreover, 3GPP has discussed the possibility of the user sending their consent to the network i.e. the consent is a form of an prior agreement from the user indicating that the provided user location information can indeed by used by the network. However even if this is done, the issue remains i.e. the user consent will also be sent in the clear and as such it may not be guaranteed that a rogue entity did not modify a negative user consent that may have been sent by the UE, where this rogue entity may actually end up sending a false UE location and a false positive consent that a (false) location information may be used for AMF selection.

Discussions related to the determination of the UE's location based on location information that is sent to the RAN and consequently to the AMF can be found in S2-2106651 (LS Response to Reply LS on UE location aspects in NTN, 3GPP TSG SA WG2 Meeting #146E (e-meeting), Aug. 16-27 2021) [3].

In other words, in NTN there is a problem of satellite coverage leakage into neighboring countries, where a UE located in a country B (e.g. PLMN B) may detect a “leaked” coverage from a satellite that is providing coverage to country A (e.g. PLMN A). In this case, the UE may wrongly assume that it is located in country A.

Consequently, when the RAN (which is using a satellite access) selects an AMF to send the UE's (initial) NAS message, the RAN would select an AMF based on the PLMN ID that the UE has selected which in turn is a wrong PLMN ID. As such, the UE's NAS message (e.g. Registration Request) may be rejected by the AMF if it determines a mismatch with respect to the UE's location relative to the network itself.

Therefore, in NTN, it is desirable that the UE provides its location information to the network. The main solution assumption that has been discussed so far in 3GPP is one in which the UE provides its location to the RAN node and then the RAN node forwards this location information to the AMF. The AMF then verifies if the UE is actually in the country for which the selected PLMN is meant to serve. The key problem with this solution assumption is that the location information will be sent in the clear i.e. without any security protection. This is because the UE is performing an initial registration without any previous security context that is shared with the selected PLMN. As such, in the process of sending the UE's location information to the RAN, any rogue entity can acquire this information which is considered to be violating the user's privacy and/or confidentiality. Moreover, 3GPP has discussed the need to provide user consent on sending its location information to the network. However similar security issue, as that of providing location information in the initial access case, may also apply to the user consent.

This invention provides a solution to securely send/exchange UE location information and/or user consent and/or other assistance information to the network (e.g. NG-RAN, UDM, AMF, SMF, other).

### Solutions

The following section describes solution(s) to the identified problem. The solution uses the concept of initial NAS message protection to send the UE's location information to the AMF directly optionally with a user consent. This document also describes the AMF behaviour regarding how the received UE location information is used to determine its actual location (or country in which it is actually present in).

The first aspect provides a method of sending User Equipment, UE, information in and/or to a network, the method comprising:
sending, by a UE, UE Location Information, ULI, thereof, preferably directly, to the network, for example to an Access and Mobility Management Function, AMF, or Mobility Management Entity, MME, thereof, using signaling, for example Non-Access Stratum, NAS, signaling such as a NAS message, comprising protecting the signaling using a security context, for example an existing security context such as an existing security context of the UE; and/or
optionally, sending by the UE to the network, user consent and/or a Tracking Area Code, TAC, for example a detected TAC and/or a selected TAC.

The second aspect provides a method of using User Equipment, UE, information by a network, the method comprising:
receiving, by the network from a UE, for example an Access and Mobility Management Function, AMF, or Mobility Management Entity, MME, of the network, UE Location Information, ULI of the UE, via signaling, for example Non-Access Stratum, NAS, signaling such as a NAS message, comprising protecting the signaling using a security context, for example an existing security context such as an existing security context of the UE;
optionally, receiving by the network to the UE, user consent and/or a Tracking Area Code, TAC, for example a detected TAC and/or a selected TAC; and
verifying, by the network, use or request of (i.e. use of or request for) the ULI.

Generally, the solutions cover:
1. Actions performed by UE to provide its location information to the network (the first aspect); and
2. Actions performed by the network to check whether UE location information can be reported/is required, based on subscription information (e.g. user consent available from/in subscription information) (the second aspect).

Hereafter, the UE location information will be abbreviated by ULI, where this information may be obtained using any mechanism such as but not limited to GPS location or GNSS location, or any other method for obtaining location information. The location information may be represented in any manner e.g. coordinate information for two or three dimensions.

Note that all the proposals herein apply to S1 mode as well i.e. EPS/LTE, as such all UE proposals for 5GS (N1 mode) would apply for a UE in S1 mode, and all core network proposals for 5GS (N1 mode) e.g. for the AMF would equally apply for the core network node in EPS i.e. for the Mobility Management Entity (MME) of LTE and 4G. Note that the corresponding messages would be used for the proposals to apply in a corresponding manner e.g. the equivalent of a Registration Request in 5GS would be an Attach Request or Tracking Area Update (TAU) Request in EPS. Similarly, the necessary/equivalent IEs can be used in EPS.

Note that all the proposals herein apply regardless of the access type and as such are not limited to the case of satellite access. Therefore, satellite access should be considered as an example only. For example, all the proposals herein will still apply in the case of an access that is related to IoT e.g. NB-IoT access, WB-S1 mode, etc. Therefore the proposals would apply for any access type/lower layer type.
1. The UE Sends its Location Information Directly to the AMF using Security Protected NAS messages (i.e. Actions performed by UE to provide its location information to the network)

The first aspect provides a method of sending User Equipment, UE, information in and/or to a network, the method comprising:
sending, by a UE, UE Location Information, ULI, thereof, preferably directly, to the network, for example to an Access and Mobility Management Function, AMF, or Mobility Management Entity, MME, thereof, using signaling, for example Non-Access Stratum, NAS, signaling such as a NAS message, comprising protecting the signaling using a security context, for example an existing security context such as an existing security context of the UE; and/or
optionally, sending by the UE to the network, user consent and/or a Tracking Area Code, TAC, for example a detected TAC and/or a selected TAC.

Particularly, the inventors have provided a solution that addresses a security concern for an initial access case, by proposing to send UE location information to the network using NAS signaling/messages (as NAS security is applied).

This document proposes that the UE should send its location information directly to the AMF/MME in a secured manner using NAS signaling that is protected with an existing security context, where the context may be a recent context that has been activated and taken into use (e.g. after an authentication procedure and/or a security mode control procedure) or the security context may be an existing context that the UE has e.g. from a previous registration.

If the UE is performing an initial registration/initial attach (or TAU) and does not have a security context, then the UE should send its location information in the Security Mode Complete message which is sent in a ciphered and integrity protected manner as described in 3GPP TS 24.501 [2]. The UE may send this information in a new information element (IE) that is part of the Security Mode Complete message, or as a new IE as part of the entire Registration Request message which is in turn included in the NAS message container IE (which is defined in [3]).

If the UE is performing an initial registration and the UE has a valid 5G NAS security context (or a valid EPS NAS security context), the UE can/should send its location information to the network (e.g. AMF or MME) by including the location information in a new IE, where this new IE may be part of the Registration Request message that is included in the NAS message container IE, or the new IE may be included in the NAS message container IE separate from the Registration Request message (e.g. the IE may be after the Registration Request message in the NAS message container IE). In the case of EPS, the new IE may be sent in the Security Mode Complete message or any other NAS message.

Note that the UE may also behave in a similar manner when the UE is sending any other initial NAS message even when a 5G NAS security context exists. In one example, the UE sends its location information in a new IE when the UE sends a Service Request message, or a Control Plane Service Request message. In one example, the new IE is part of the NAS message container IE that contains an entire NAS message or is a single IE that is included in the NAS message container IE. For example, in EPS, the new IE may be sent in a Tracking Area Update Request message. Note that the proposal to send location information (or other type of information e.g. user consent, etc) in any NAS message when the UE has a valid NAS security context (EPS or 5GS) applies to both EPS and 5GS i.e. to S1 mode and N1 mode respectively.

The proposals above may also be applicable to the case when the UE sends Deregistration Request message (for N1 mode) or Detach Request message (for S1 mode). In this case, the NAS message container IE, or any other IE, should be included in the Deregistration Request message (or the Detach Request message) and the IE may be part of the NAS message container IE such that the new IE is either part of the Deregistration Request message or may be considered to be a single IE that is part of the NAS message container IE. In the case of EPS, the IE may be included as a new IE in the Detach Request message.

In the case when the UE is sending a Registration Request (or any other NAS message) as described above either in N1 mode or S1 mode, the UE may further indicate that the NAS message contains UE location information. In one example, the UE indicates that the NAS message contains UE location information using:
A capability indication which informs the network about the UE's capability to send/include a location information in the NAS message; and/or
Another indication e.g. a new indication, in the 5GS update type IE (in the case of N1 mode), where for example a new bit can be used to indicate that UE location information is included in the message. For example a new indication (e.g. a new bit) can be defined in the EPS attach type IE for the case of S1 mode; and/or
Another indication in the form of a new IE or an new bit/field in any existing IE of any NAS message to inform the network about the presence of UE location information. This also applies to both S1 mode and N1 mode.

In one example, the UE includes user consent (or information about the user consent) regarding the use of location information included in the NAS message. In one example, the user (or upper layers, or e.g. user interacting with the UE via a graphical user interface, or via other pre-determined settings/configuration in the UE) provides consent information (or information related to user consent) regarding whether the location information (if any is included in the NAS message) can be used by the network or not (e.g. for any reason or specifically for determining the UE's location by the network, for example by the AMF or by the MME). In one example, the consent information is sent using a new IE in any of the NAS messages, or using e.g. a bit position in any existing field/IE of a NAS message. For example, if the message is a Registration Request message for N1 mode (or Attach Request or TAU Request in S1 mode), the user consent can be sent in the form of a new IE, or an existing IE e.g. the 5GS update type IE (or any existing/new IE for the case of S1 mode), can be used such that one bit position can provide the user consent, where for example a bit value of 1 indicates that the user consents to the location information being used, and a bit value of 0 indicates that the user does not consent to the use of the location information at the network.

In one example, the presence of the location information in a NAS message is implicitly considered (e.g. by the network, such as the AMF or the MME) as the user consenting to the location information being used by the network (AMF or MME).

In one example, the UE provides its location information (e.g. using a new IE) in any NAS message e.g. UL NAS TRANSPORT message or any existing message in N1 mode or S1 mode, or in any 5GSM message in N1 mode or any ESM message in S1 mode. In one example, the, the AMF (or MME) forwards any received UE location information to other nodes in the network such as an SMF (or PGW-C+SMF in the case of S1 mode), where the SMF (or PGW-C+SMF in the case of S1 mode) may also use this information to determine the UE's location. If the SMF (or PGW-C+SMF in the case of S1 mode) receives a UE location information, either from an AMF (e.g. in addition to a 5GSM message that is forwarded by the AMF, or from the MME), or directly from the UE in a 5GSM message (or ESM message), and the SMF (or PGW-C+SMF in the case of S1 mode) determines that the UE location information does not meet the relevant criteria (or criterion, e.g. the SMF (or PGW-C+SMF in the case of S1 mode) determines that the UE is not in the right location, etc), then the SMF (or PGW-C+SMF in the case of S1 mode) may reject the request with an appropriate cause value, where this cause value may be a new value that is defined.

In one example, the UE (in S1 mode or N1 mode) is configured to operate as described above, where this configuration may be part of the USIM, or provided to the UE using any NAS message or the UE may be preconfigured accordingly.

In one example, the UE operates using any combinations of the methods described above and/or in any order.

In one example, the UE behaves as described above (i.e. the UE also includes its location information when sending any initial NAS message, e.g. the Control Plane Service Request message or the Service Request message) when the UE selects a PLMN that is an equivalent PLMN, or when the UE selects a PLMN that is not an equivalent PLMN where the UE may be sending its first NAS message in this selected PLMN.

In one example, the UE is configured with any of the following and/or is configured to operate using any combination of the following methods:
A list of countries and/or PLMNs and/or MCC values for which the UE should behave as described above e.g. when the UE is in any of these countries, or the MCC of the selected PLMN matches any of the MCC in this list, or the selected PLMN matches any PLMN in the list, then the UE should provide its location information and/or consent, etc, as described above
A ‘user consent validity location/area’ which defines the area/location in which the UE behaves as described above. E.g. if the UE is in any of this validity area/location, then the UE behaves as described above, otherwise the UE does not provide its location information, consent, etc. Note that this may also be implemented as a ‘non-validity area/location’ such that if the UE is inside this ‘non-valid’ area, then the UE does not provide its location information, otherwise the UE behaves as defined above if the UE is outside of the non-valid area/location. Note that the area/location may also represent a country, a PLMN, or MCC, etc
The UE may send a NAS message to indicate whether the (or previous) UE location information should no longer be used, or whether the UE wants to change its consent (e.g. from no consent to consent, or from a previous consent to no consent). The UE may use any NAS message to do so e.g. a Registration Request message for N1 mode (or Attach Request or TAU Request for S1 mode). Therefore, any NAS message can be used by the UE to update its preferences (e.g. to activate, deactivate, modify, etc) regarding the network's ability to use the UE location and/or consent. Note that for all the proposals herein, new NAS messages may also be defined to achieve the proposed methods.

In one example, the UE reports its selected Tracking Area Code (TAC), or Tracking Area Identity (TAI), hereafter both referred to as TAC, to the AMF (or to the MME) using any NAS message as described previously for the case of the UE sending its location information to the AMF (or to the MME). As such, all the proposals above would apply in a similar manner for the UE sending its selected TAC.

In one example, the UE reports all of the detected TACs in case multiple TACs have been detected. In one example, the UE reports all detected TACs and/or the selected TAC which is one out of the detected TACs. The UE may do so using a new IE and using any NAS message e.g. Registration Request message in N1 mode (or Attach Request or TAU Request in S1 mode).
2. Use of UE Location Information that is Received in a NAS Message (i.e. Actions performed by the network to check whether UE location information can be reported/may be required, based on subscription information (e.g. user consent available from/in subscription information)

The second aspect provides a method of using User Equipment, UE, information by a network, the method comprising:
receiving, by the network from a UE, for example an Access and Mobility Management Function, AMF, or Mobility Management Entity, MME, of the network, UE Location Information, ULI of the UE, via signaling, for example Non-Access Stratum, NAS, signaling such as a NAS message, comprising protecting the signaling using a security context, for example an existing security context such as an existing security context of the UE;
optionally, receiving by the network to the UE, user consent and/or a Tracking Area Code, TAC, for example a detected TAC and/or a selected TAC; and
verifying, by the network, use or request of the ULI.

In one example, the AMF (or MME) receives a NAS message which includes UE location information and/or user consent (e.g. as described earlier), and/or detected TACs and/or selected TAC as described earlier. The AMF (or MME) may act in any combination of the following and/or in any order:
The AMF (or MME) may verify if the UE supports the reporting of UE location information and/or consent
The AMF (or MME) may verify if the UE location information can be used (if provided by the UE) from this UE based on any of the following:

Subscription information (e.g. that may have been received from the UDM or HSS), where the subscription information may indicate if any of the following: use of UE location information is required, is optional, etc, where this may be based on the country in question (where the network is located), or the PLMN, etc (for example, whether user consent is required may depend on local regulations, such as in regions where user consent is required for NTN, the user consent requirement be met via provisional means, e.g. per gNB/NTN-GW configuration (consent granted for all UEs subscribing for NTN) based on the service-level agreement between the operator and its NTN subscribers). For example, the network may decide whether there is a user consent for the aforementioned location request (based on subscription-based means or proprietary mechanisms) and not the UE. In other words, the network should request for the location if there is user consent (based on subscription-based or proprietary mechanisms) and the network should not request for the location if there is no user consent. The UE should provide the location information (if available) if the network requests for it.
UE/user consent that may have been received in a NAS message (or from the subscription information) such that the consent confirms that the UE location information can be used (i.e. a positive consent) (for example, NTN-specific user consent, at least based on subscription)
The UE location information received is within a known validity area/location/country, etc, where this area may be known to the AMF (or MME) e.g. based on local policies or subscription information, etc
E.g. if the location information received does not comply with the validity area then the AMF (or MME) may ignore this information
The UE location information received is within a known validity time, etc, where this area may be known to the AMF (or MME) e.g. based on local policies or subscription information, etc
E.g. if the location information received does not comply with the validity time then the AMF (or MME) may ignore this information
The AMF (or MME) is aware that the RAN is connected to multiple AMFs (or MMEs), optionally to multiple AMFs (or MMEs) serving different countries (or multiple AMFs/MMEs that belong in/to different countries). This may be known at the AMF (or MME) based on local polices, or based on an indication from the RAN to the AMF/MME (e.g. using any N2 protocol message/S1 protocol message).
As such, it is proposed that the RAN should indicate to the AMF (or MME) if the RAN connect to multiple AMFs/MMEs or to multiple AMFs/MMEs in multiples countries. Optionally the RAN can do so when the access used is a satellite access

When the AMF (or MME) receives UE location information in any NAS message, and the AMF (or MME) determines that the UE location information can be used to determine if the AMF (or MME) can serve the UE or not, e.g. where this determination may be based on any of the above or may be based on verifying that the UE/use consents that the network can use this information (where this consent may be based on a consent in that is received in a NAS message or based on subscription information), then the AMF (or MME) may take any combinations of the following actions:
The AMF (or MME) may determine the current UE location and/or country based on a verifying the UE provided location information versus the location information of the cell that is serving the UE. The location information of the cell that is serving the UE may be based on a mapping of a Tracking Area Identity (TAI) or Tracking Area Code (TAC) that the cell is broadcasting, where this information may be known to the AMF (or MME) or may be received from the RAN
If the AMF (or MME) determines that the UE location information is not within the location of the serving cell, or the UE location is outside the location or the area of the serving cell (e.g. the area covered by the TAC or TAI of the serving cell), then the AMF (or MME) rejects the UE's request/NAS message
The AMF (or MME) may forward the UE location information and/or consent to other network entities e.g. to the SMF (or PGW-C+SMF), where this information may be sent with a 5GSM/ESM message that may have been received at the AMF/MME (optionally from the UE). That is, the network (e.g. AMF) may provide information on user consent to other network entities (e.g. RAN node).

When the AMF (or MME) receives a NAS message with TACs that are detected by the UE and/or a selected TAC, the AMF (or MME) may verify if the selected TAC corresponds to a location that this AMF (or MME) can serve, or it corresponds to a location that another AMF (or MME) should serve. This determination may be based on local information (e.g. knowledge of the geographic location of TACs in the serving radio cell). This information could be provided to the AMF (or MME) via pre-configuration (e.g. OAM). The AMF (or MME) may compare UE location information against the TACs geographic locations (e.g. perform some sort of mapping between TAC(s) locations and the UE location information).

When the AMF (or MME) receive from the RAN a message (e.g. NAS Transport message, INITIAL UE MESSAGE, or any other suitable existing or newly defined message), that includes one or more (or all) TACs detected by the RAN (e.g. one or more (or all) TACs broadcast by UE's serving cell, or TAC(s) in UE's Registration Area, or other TACs), the AMF (or MME) may select from the RAN reported TACs a suitable TAC that corresponds to the UE location information, available at the AMF (or MME). The AMF or (MME) may provide the selected TAC and/or UE location information to the RAN (e.g. in INITIAL CONTEXT SETUP REQUEST message, or any other existing or newly defined message). For example, the AMF (or MME) may store the UE location information in the UE context.

When the AMF (or MME) receive from the RAN a message (e.g. NAS Transport message, INITIAL UE MESSAGE, or any other suitable existing or newly defined message), that includes the TAC selected by the RAN, for example, based on the RAN knowledge of the UE location information (e.g. acquired from the UE or CN node AMF (or MME)), the AMF (or MME) may verify the selected TAC against the UE location information, available at the AMF (or MME). This verification may be performed by AMF (or MME) to ensure that the RAN's selected TAC corresponds to the UE geographic location. The AMF (or MME) may determine that the UE location information does not corresponds to the selected TAC. For example, the RAN may have selected the TAC without any knowledge of UE location information (i.e. UE location information is not available at the RAN), or the RAN may have selected the TAC based on inaccurate or not suitable granularity location information, then the AMF (or MME) may indicate to the RAN that the selected TAC is incorrect/not suitable/does not corresponds to the UE location information, and additionally may send the UE location information to the RAN. The RAN may re-send to AMF (or MME) the TAC that corresponds to the newly acquired UE location information.

The AMF (or MME) may determine that the UE location information usage has changed (e.g. should no longer be used, or should be used), or that the user consent has changed (e.g. user no longer consents, or user consents), or that the reported TACs or selected TAC does not correspond to the location that the AMF (or MME) can serve. This determination may be based on any combination of the following:
A NAS message is received (e.g. from the UE) containing an updated information about UE location and/or consent
An updated/new subscription information is received (optionally from the UDM/HSS) containing this update
As such, it is proposed that the UDM/HSS should update the AMF (or MME) with, or inform the AMF (or MME) of, any changes to the subscription information where the change may be as described above (e.g. change of user consent, etc)
If the AMF (or MME) determines that:
The UE location information should now be used, then the AMF (or MME) may:
Reject the UE's request if the request does not include UE location information, or deregister the UE if the UE is already registered but the AMF (or MME) does not have the UE location information. In this case, a new cause value may be used e.g. “No location information”, “Non-valid User Consent”, etc.
Send a NAS message to the UE to request the UE location information and/or user consent
Send a request to the RAN indicating the need for the RAN to get UE location information
When the AMF (or MME) receives the UE location, using any of the methods listed above, then the AMF (or MME) can take any of the actions that were previously described
The UE location should no longer be used (e.g. user consent has change to negative consent), then the AMF (or MME) may:
Delete any location information that is saved in the UE context
AMF (or MME) may initiate UE context release with RAN node (e.g. over the N2 interface or S1-AP interface), and optionally include a new cause value e.g., “User Consent Update”, “No User Consent”, or any other suitable cause value, or an existing cause value may be re-used
Request other nodes to delete any location information for this UE, or request the SMF (or PGW-C+SMF) to release PDU sessions (or PDN connections) that were established prior to the change in the AMF/MME determination (as described above)
Deregister the UE if the AMF/MME policy requires the UE location to always be used
In any of the above cases, when the AMF (or MME) deregisters the UE or requests a UE to provide location information and/or consent, the AMF (or MME) may use a new cause value in the NAS message (e.g. UE location and/or consent required)
The UE reported TACs and/or selected TAC is determined by the AMF/MME (as described earlier) to correspond to an area/location/country that is not served by this AMF (or this MME), or that corresponds to an area/location/country that should be served by another AMF/MME (optionally in another country/area/location). When this happens, the AMF (or MME) may determine to reject the UE's NAS message using any of the methods proposed above for the case when the AMF (or MME) rejects the UE's NAS message based on any of the above reasons to reject a NAS message

The AMF (or MME) may determine, based on any of the above, that it cannot/should not serve the UE based on e.g. UE reported location information, UE selected TAC, or any combination of the previous information that the UE was proposed to send, and optionally other local AMF/MME policies. When this occurs, the AMF (or MME) may take the following actions:
The AMF (or MME) need not reject the NAS message
The AMF (or MME) sends the NAS message to the RAN and requests the RAN to re-route the NAS message to another AMF (or another MME) in another location
While doing so, the AMF (or MME) may indicate the target location/country of the AMF (or MME) where the NAS message should be re-routed to by the RAN. The AMF (or MME) may determine this information based on the information received in the NAS message from the UE and optionally based on the mapping information that the AMF/MME has (or any other information as described earlier) which is used to determine the country/location/area that the UE is truly in and hence the country/area/location of the AMF (or MME) that should be serving the UE
The AMF (or MME) may include this information in the N2 REROUTE NAS REQUEST message (or S1-AP Reroute NAS Request message) that is sent to the RAN, optionally the AMF (or MME) includes a target AMF ID (MME ID, or MME group ID, etc) where this is determined locally in the AMF (or MME) based on a mapping of e.g. UE location and/or selected TAC to target AMF ID (or target AMF country/area/location)/target MME ID (or target MME country/area/location).
Upon reception of a re-route request by the RAN (optionally received from an AMF over the N2 message/protocol, or from an MME over the S1-AP message/protocol), where optionally the message also contains a target country/location/area and/or UE reported TACs and/or UE selected TAC, the RAN should forward the NAS message to an appropriate/target AMF (or appropriate/target MME). The RAN determines the target AMF (or MME) based on the received target AMF ID/MME ID and/or target AMF country/area/location (or MME country/area/location) or selected TAC. In the case of a selected TAC, the RAN should use local information/configuration to determine the target AMF/MME based on this selected TAC, where the RAN may be preconfigured with such location information/mapping, etc. The RAN may determine the UE location based on the location information that is received from the AMF/MME. The RAN may determine a target AMF (or MME) based on the determined UE location as described herein. The RAN then re-routes or forwards the NAS message (which is received from the CN i.e. AMF (or MME)) to the determined CN node i.e. AMF (or MME).
When forwarding the NAS message to a target AMF (or target MME), the RAN may also include the UE selected TAC and/or determined target area/country/location (that was determined as described above).
The AMF (or MME) may also forward a user consent (e.g. NTN specific user consent) to the RAN where this indicates whether or not the UE location can be acquired and/or can be used by the RAN. The RAN may receive a user consent from the AMF (or MME) (or an indication about whether the UE location can be acquired or used), where the RAN may then determine to acquire/use the UE location as described herein if the consent/indication has a value such indicating that the UE location can indeed be acquired/used.
If the RAN receives a user consent indication that the RAN should not acquire and/or use the UE location information, then the RAN should, e.g., release the UE. The RAN may also send UE context release request to the CN node AMF (or MME) to release the UE. The RAN may include an appropriate cause value (e.g. “No User Consent”, “No NTN User Consent”, or any other suitable cause name).

Note that all the proposals above could be used in any order and combinations.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

The following problem has been identified by the inventors.

Assume the satellite coverage “leaks” into neighboring countries where a UE in a Country B receives/detects “leaked” coverage from a satellite that is providing coverage for Country A as shown in FIG. 2. In this case, the UE will wrongly assume that it is in Country A since the PLMN ID (say e.g. PLMN A) that is detected by the UE (from the broadcast information of the cross-border leakage) will contain a Mobile Country Code (MCC) pointing to Country A.

Therefore the detection of this cross-border leakage leads to a wrong PLMN selection of a UE i.e. the UE selects PLMN A (since it is detected) as opposed to the PLMN(s) within Country B where the UE is actually located.

In summary, the cross-border leakage creates cases in which the UE wrongly assumes to be in one location/country whereas the UE is actually in a different location/country. Consequently, when the RAN (which is now using a satellite access) selects an AMF in order to send the UE's (initial) NAS message, the RAN would select an AMF based on the PLMN ID that the UE has selected which in turn is a wrong PLMN ID. As such, the UE's NAS message (e.g. Registration Request) may be rejected by the AMF if the latter determines a mismatch with respect to the UE's location relative to the network itself.

One of the related problems, which is what this document strives to solve, is regarding how the AMF comes to know the true location of the UE. The main solution assumption that has been discussed so far in 3GPP is one in which the UE provides an estimate of its location to the RAN node and then the RAN node forwards this location information to the AMF. The AMF then verifies if the UE is actually in the country for which the selected PLMN is meant to serve. The key problem with this solution assumption is that the location information will be sent in the clear i.e. without any security protection. This is because the UE is performing an initial registration without any previous security context that is shared with the selected PLMN. As such, in the process of sending the UE's location information to the RAN, any rogue entity can acquire this information which is considered to be violating the user's privacy and/or confidentiality. Moreover, 3GPP has discussed the possibility of the user sending their consent to the network i.e. the consent is a form of an prior agreement from the user indicating that the provided user location information can indeed by used by the network. However even if this is done, the issue remains i.e. the user consent will also be sent in the clear and as such it may not be guaranteed that a rogue entity did not modify a negative user consent that may have been sent by the UE, where this rogue entity may actually end up sending a false UE location and a false positive consent that a (false) location information may be used for AMF selection.

Discussions related to the determination of the UE's location based on location information that is sent to the RAN and consequently to the AMF can be found in [3].

In other words, in NTN there is a problem of satellite coverage leakage into neighboring countries, where a UE located in a country B (e.g. PLMN B) may detect a “leaked” coverage from a satellite that is providing coverage to country A (e.g. PLMN A). In this case, the UE may wrongly assume that it is located in country A.

Consequently, when the RAN (which is using a satellite access) selects an AMF to send the UE's (initial) NAS message, the RAN would select an AMF based on the PLMN ID that the UE has selected which in turn is a wrong PLMN ID. As such, the UE's NAS message (e.g. Registration Request) may be rejected by the AMF if it determines a mismatch with respect to the UE's location relative to the network itself.

Therefore, in NTN, it is desirable that the UE provides its location information to the network. The main solution assumption that has been discussed so far in 3GPP is one in which the UE provides its location to the RAN node and then the RAN node forwards this location information to the AMF. The AMF then verifies if the UE is actually in the country for which the selected PLMN is meant to serve. The key problem with this solution assumption is that the location information will be sent in the clear i.e. without any security protection. This is because the UE is performing an initial registration without any previous security context that is shared with the selected PLMN. As such, in the process of sending the UE's location information to the RAN, any rogue entity can acquire this information which is considered to be violating the user's privacy and/or confidentiality. Moreover, 3GPP has discussed the need to provide user consent on sending its location information to the network. However similar security issue, as that of providing location information in the initial access case, may also apply to the user consent.

This invention provides a solution to securely send/exchange UE location information and/or user consent and/or other assistance information to the network (e.g. NG-RAN, UDM, AMF, SMF, other).

### Solutions

The following section describes solution(s) to the identified problem. The solution uses the concept of initial NAS message protection to send the UE's location information to the AMF directly optionally with a user consent. This document also describes the AMF behaviour regarding how the received UE location information is used to determine its actual location (or country in which it is actually present in).

Generally, the solutions cover:
1. Actions performed by UE to provide its location information to the network; and
2. Actions performed by the network to check whether UE location information can be reported/is required, based on subscription information (e.g. user consent available from/in subscription information).

Hereafter, the UE location information will be abbreviated by ULI, where this information may be obtained using any mechanism such as but not limited to GPS location or GNSS location, or any other method for obtaining location information. The location information may be represented in any manner e.g. coordinate information for two or three dimensions.

Note that all the proposals herein apply to S1 mode as well i.e. EPS/LTE, as such all UE proposals for 5GS (N1 mode) would apply for a UE in S1 mode, and all core network proposals for 5GS (N1 mode) e.g. for the AMF would equally apply for the core network node in EPS i.e. for the Mobility Management Entity (MME) of LTE and 4G. Note that the corresponding messages would be used for the proposals to apply in a corresponding manner e.g. the equivalent of a Registration Request in 5GS would be an Attach Request or Tracking Area Update (TAU) Request in EPS. Similarly, the necessary/equivalent IEs can be used in EPS.

Note that all the proposals herein apply regardless of the access type and as such are not limited to the case of satellite access. Therefore, satellite access should be considered as an example only. For example, all the proposals herein will still apply in the case of an access that is related to IoT e.g. NB-IoT access, WB-S1 mode, etc. Therefore the proposals would apply for any access type/lower layer type.
1. The UE Sends its Location Information Directly to the AMF using Security Protected NAS messages (i.e. Actions performed by UE to provide its location information to the network) Particularly, the inventors have provided a solution that addresses a security concern for an initial access case, by proposing to send UE location information to the network using NAS signaling/messages (as NAS security is applied).

This document proposes that the UE should send its location information directly to the AMF/MME in a secured manner using NAS signaling that is protected with an existing security context, where the context may be a recent context that has been activated and taken into use (e.g. after an authentication procedure and/or a security mode control procedure) or the security context may be an existing context that the UE has e.g. from a previous registration.

If the UE is performing an initial registration/initial attach (or TAU) and does not have a security context, then the UE should send its location information in the Security Mode Complete message which is sent in a ciphered and integrity protected manner as described in 3GPP TS 24.501 [2]. The UE may send this information in a new information element (IE) that is part of the Security Mode Complete message, or as a new IE as part of the entire Registration Request message which is in turn included in the NAS message container IE (which is defined in [3]).

If the UE is performing an initial registration and the UE has a valid 5G NAS security context (or a valid EPS NAS security context), the UE can/should send its location information to the network (e.g. AMF or MME) by including the location information in a new IE, where this new IE may be part of the Registration Request message that is included in the NAS message container IE, or the new IE may be included in the NAS message container IE separate from the Registration Request message (e.g. the IE may be after the Registration Request message in the NAS message container IE). In the case of EPS, the new IE may be sent in the Security Mode Complete message or any other NAS message.

Note that the UE may also behave in a similar manner when the UE is sending any other initial NAS message even when a 5G NAS security context exists. For example, the UE may send its location information in a new IE when the UE sends a Service Request message, or a Control Plane Service Request message. The new IE may be part of the NAS message container IE that contains an entire NAS message or may be a single IE that is included in the NAS message container IE. For example, in EPS, the new IE may be sent in a Tracking Area Update Request message. Note that the proposal to send location information (or other type of information e.g. user consent, etc) in any NAS message when the UE has a valid NAS security context (EPS or 5GS) applies to both EPS and 5GS i.e. to S1 mode and N1 mode respectively.

The proposals above may also be applicable to the case when the UE sends Deregistration Request message (for N1 mode) or Detach Request message (for S1 mode). In this case, the NAS message container IE, or any other IE, should be included in the Deregistration Request message (or the Detach Request message) and the IE may be part of the NAS message container IE such that the new IE is either part of the Deregistration Request message or may be considered to be a single IE that is part of the NAS message container IE. In the case of EPS, the IE may be included as a new IE in the Detach Request message.

In the case when the UE is sending a Registration Request (or any other NAS message) as described above either in N1 mode or S1 mode, the UE may further indicate that the NAS message contains UE location information. For example, this indication may be any of the following:
A capability indication which informs the network about the UE's capability to send/include a location information in the NAS message
Another indication e.g. a new indication, in the 5GS update type IE (in the case of N1 mode), where for example a new bit can be used to indicate that UE location information is included in the message. For example a new indication (e.g. a new bit) can be defined in the EPS attach type IE for the case of S1 mode
Another indication in the form of a new IE or an new bit/field in any existing IE of any NAS message to inform the network about the presence of UE location information. This also applies to both S1 mode and N1 mode

Additionally, the UE may (also) include user consent (or information about the user consent) regarding the use of location information that may be included in the NAS message. The user (or upper layers, or e.g. user interacting with the UE via a graphical user interface, or via other pre-determined settings/configuration in the UE) may provide consent information (or information related to user consent) regarding whether the location information (if any is included in the NAS message) can be used by the network or not (e.g. for any reason or specifically for determining the UE's location by the network, for example by the AMF or by the MME). The consent information may be sent using a new IE in any of the NAS messages, or using e.g. a bit position in any existing field/IE of a NAS message. For example, if the message is a Registration Request message for N1 mode (or Attach Request or TAU Request in S1 mode), the user consent can be sent in the form of a new IE, or an existing IE e.g. the 5GS update type IE (or any existing/new IE for the case of S1 mode), can be used such that one bit position can provide the user consent, where for example a bit value of 1 indicates that the user consents to the location information being used, and a bit value of 0 indicates that the user does not consent to the use of the location information at the network.

Alternatively, the mere presence of the location information in a NAS message may be implicitly considered (e.g. by the network, such as the AMF or the MME) as the user consenting to the location information being used by the network (AMF or MME).

Note that the UE may also provide its location information (e.g. using a new IE) in any NAS message e.g. UL NAS TRANSPORT message or any existing message in N1 mode or S1 mode, or in any 5GSM message in N1 mode or any ESM message in S1 mode. Alternatively, the AMF (or MME) can/should forward any received UE location information to other nodes in the network such as an SMF (or PGW-C+SMF in the case of S1 mode), where the SMF (or PGW-C+SMF in the case of S1 mode) may also use this information to determine the UE's location. If the SMF (or PGW-C+SMF in the case of S1 mode) receives a UE location information, either from an AMF (e.g. in addition to a 5GSM message that is forwarded by the AMF, or from the MME), or directly from the UE in a 5GSM message (or ESM message), and the SMF (or PGW-C+SMF in the case of S1 mode) determines that the UE location information does not meet the relevant criteria (or criterion, e.g. the SMF (or PGW-C+SMF in the case of S1 mode) determines that the UE is not in the right location, etc), then the SMF (or PGW-C+SMF in the case of S1 mode) may reject the request with an appropriate cause value, where this cause value may be a new value that is defined.

Note that the UE (in S1 mode or N1 mode) may be configured to operate as described above, where this configuration may be part of the USIM, or provided to the UE using any NAS message or the UE may be preconfigured accordingly.

The UE may operate using any combinations of the methods described above and/or in any order.

The UE may behave as described above (i.e. the UE also includes its location information when sending any initial NAS message, e.g. the Control Plane Service Request message or the Service Request message) when the UE selects a PLMN that is an equivalent PLMN, or when the UE selects a PLMN that is not an equivalent PLMN where the UE may be sending its first NAS message in this selected PLMN.

Additionally, the UE may be configured with any of the following or may be configured to operate using any combination of the following methods:
A list of countries and/or PLMNs and/or MCC values for which the UE should behave as described above e.g. when the UE is in any of these countries, or the MCC of the selected PLMN matches any of the MCC in this list, or the selected PLMN matches any PLMN in the list, then the UE should provide its location information and/or consent, etc, as described above
A ‘user consent validity location/area’ which defines the area/location in which the UE behaves as described above. E.g. if the UE is in any of this validity area/location, then the UE behaves as described above, otherwise the UE does not provide its location information, consent, etc. Note that this may also be implemented as a ‘non-validity area/location’ such that if the UE is inside this ‘non-valid’ area, then the UE does not provide its location information, otherwise the UE behaves as defined above if the UE is outside of the non-valid area/location. Note that the area/location may also represent a country, a PLMN, or MCC, etc
The UE may send a NAS message to indicate whether the (or previous) UE location information should no longer be used, or whether the UE wants to change its consent (e.g. from no consent to consent, or from a previous consent to no consent). The UE may use any NAS message to do so e.g. a Registration Request message for N1 mode (or Attach Request or TAU Request for S1 mode). Therefore, any NAS message can be used by the UE to update its preferences (e.g. to activate, deactivate, modify, etc) regarding the network's ability to use the UE location and/or consent. Note that for all the proposals herein, new NAS messages may also be defined to achieve the proposed methods.

In addition to any of the proposals above, the UE may also report its selected Tracking Area Code (TAC), or Tracking Area Identity (TAI), hereafter both referred to as TAC, to the AMF (or to the MME) using any NAS message as described previously for the case of the UE sending its location information to the AMF (or to the MME). As such, all the proposals above would apply in a similar manner for the UE sending its selected TAC.

The UE may also report all of the detected TACs in case multiple TACs have been detected. The UE may report all detected TACs and/or the selected TAC which may be one out of the detected TACs. The UE may do so using a new IE and using any NAS message e.g. Registration Request message in N1 mode (or Attach Request or TAU Request in S1 mode).
2. Use of UE Location Information that is Received in a NAS Message (i.e. Actions performed by the network to check whether UE location information can be reported/may be required, based on subscription information (e.g. user consent available from/in subscription information)

The AMF (or MME) may receive a NAS message which includes UE location information and/or user consent (e.g. as described earlier), and/or detected TACs and/or selected TAC as described earlier. The AMF (or MME) may act in any combination of the following and/or in any order:
The AMF (or MME) may verify if the UE supports the reporting of UE location information and/or consent
The AMF (or MME) may verify if the UE location information can be used (if provided by the UE) from this UE based on any of the following:
Subscription information (e.g. that may have been received from the UDM or HSS), where the subscription information may indicate if any of the following: use of UE location information is required, is optional, etc, where this may be based on the country in question (where the network is located), or the PLMN, etc (for example, whether user consent is required may depend on local regulations, such as in regions where user consent is required for NTN, the user consent requirement be met via provisional means, e.g. per gNB/NTN-GW configuration (consent granted for all UEs subscribing for NTN) based on the service-level agreement between the operator and its NTN subscribers). For example, the network may decide whether there is a user consent for the aforementioned location request (based on subscription-based means or proprietary mechanisms) and not the UE. In other words, the network should request for the location if there is user consent (based on subscription-based or proprietary mechanisms) and the network should not request for the location if there is no user consent. The UE should provide the location information (if available) if the network requests for it.
UE/user consent that may have been received in a NAS message (or from the subscription information) such that the consent confirms that the UE location information can be used (i.e. a positive consent) (for example, NTN-specific user consent, at least based on subscription)
The UE location information received is within a known validity area/location/country, etc, where this area may be known to the AMF (or MME) e.g. based on local policies or subscription information, etc
E.g. if the location information received does not comply with the validity area then the AMF (or MME) may ignore this information
The UE location information received is within a known validity time, etc, where this area may be known to the AMF (or MME) e.g. based on local policies or subscription information, etc
E.g. if the location information received does not comply with the validity time then the AMF (or MME) may ignore this information
The AMF (or MME) is aware that the RAN is connected to multiple AMFs (or MMEs), optionally to multiple AMFs (or MMEs) serving different countries (or multiple AMFs/MMEs that belong in/to different countries). This may be known at the AMF (or MME) based on local polices, or based on an indication from the RAN to the AMF/MME (e.g. using any N2 protocol message/S1 protocol message).
As such, it is proposed that the RAN should indicate to the AMF (or MME) if the RAN connect to multiple AMFs/MMEs or to multiple AMFs/MMEs in multiples countries. Optionally the RAN can do so when the access used is a satellite access

When the AMF (or MME) receives UE location information in any NAS message, and the AMF (or MME) determines that the UE location information can be used to determine if the AMF (or MME) can serve the UE or not, e.g. where this determination may be based on any of the above or may be based on verifying that the UE/use consents that the network can use this information (where this consent may be based on a consent in that is received in a NAS message or based on subscription information), then the AMF (or MME) may take any combinations of the following actions:
The AMF (or MME) may determine the current UE location and/or country based on a verifying the UE provided location information versus the location information of the cell that is serving the UE. The location information of the cell that is serving the UE may be based on a mapping of a Tracking Area Identity (TAI) or Tracking Area Code (TAC) that the cell is broadcasting, where this information may be known to the AMF (or MME) or may be received from the RAN
If the AMF (or MME) determines that the UE location information is not within the location of the serving cell, or the UE location is outside the location or the area of the serving cell (e.g. the area covered by the TAC or TAI of the serving cell), then the AMF (or MME) rejects the UE's request/NAS message
The AMF (or MME) may forward the UE location information and/or consent to other network entities e.g. to the SMF (or PGW-C+SMF), where this information may be sent with a 5GSM/ESM message that may have been received at the AMF/MME (optionally from the UE)

When the AMF (or MME) receives a NAS message with TACs that are detected by the UE and/or a selected TAC, the AMF (or MME) may verify if the selected TAC corresponds to a location that this AMF (or MME) can serve, or it corresponds to a location that another AMF (or MME) should serve. This determination may be based on local information (e.g. knowledge of the geographic location of TACs in the serving radio cell). This information could be provided to the AMF (or MME) via pre-configuration (e.g. OAM). The AMF (or MME) may compare UE location information against the TACs geographic locations (e.g. perform some sort of mapping between TAC(s) locations and the UE location information).

When the AMF (or MME) receive from the RAN a message (e.g. NAS Transport message, INITIAL UE MESSAGE, or any other suitable existing or newly defined message), that includes one or more (or all) TACs detected by the RAN (e.g. one or more (or all) TACs broadcast by UE's serving cell, or TAC(s) in UE's Registration Area, or other TACs), the AMF (or MME) may select from the RAN reported TACs a suitable TAC that corresponds to the UE location information, available at the AMF (or MME). The AMF or (MME) may provide the selected TAC and/or UE location information to the RAN (e.g. in INITIAL CONTEXT SETUP REQUEST message, or any other existing or newly defined message). For example, the AMF (or MME) may store the UE location information in the UE context.

When the AMF (or MME) receive from the RAN a message (e.g. NAS Transport message, INITIAL UE MESSAGE, or any other suitable existing or newly defined message), that includes the TAC selected by the RAN, for example, based on the RAN knowledge of the UE location information (e.g. acquired from the UE or CN node AMF (or MME)), the AMF (or MME) may verify the selected TAC against the UE location information, available at the AMF (or MME). This verification may be performed by AMF (or MME) to ensure that the RAN's selected TAC corresponds to the UE geographic location. The AMF (or MME) may determine that the UE location information does not corresponds to the selected TAC. For example, the RAN may have selected the TAC without any knowledge of UE location information (i.e. UE location information is not available at the RAN), or the RAN may have selected the TAC based on inaccurate or not suitable granularity location information, then the AMF (or MME) may indicate to the RAN that the selected TAC is incorrect/not suitable/does not corresponds to the UE location information, and additionally may send the UE location information to the RAN. The RAN may re-send to AMF (or MME) the TAC that corresponds to the newly acquired UE location information.

The AMF (or MME) may determine that the UE location information usage has changed (e.g. should no longer be used, or should be used), or that the user consent has changed (e.g. user no longer consents, or user consents), or that the reported TACs or selected TAC does not correspond to the location that the AMF (or MME) can serve. This determination may be based on any combination of the following:
A NAS message is received (e.g. from the UE) containing an updated information about UE location and/or consent
An updated/new subscription information is received (optionally from the UDM/HSS) containing this update
As such, it is proposed that the UDM/HSS should update the AMF (or MME) with, or inform the AMF (or MME) of, any changes to the subscription information where the change may be as described above (e.g. change of user consent, etc)
If the AMF (or MME) determines that:
The UE location information should now be used, then the AMF (or MME) may:
Reject the UE's request if the request does not include UE location information, or deregister the UE if the UE is already registered but the AMF (or MME) does not have the UE location information. In this case, a new cause value may be used e.g. “No location information”, “Non-valid User Consent”, etc.
Send a NAS message to the UE to request the UE location information and/or user consent
Send a request to the RAN indicating the need for the RAN to get UE location information
When the AMF (or MME) receives the UE location, using any of the methods listed above, then the AMF (or MME) can take any of the actions that were previously described
The UE location should no longer be used (e.g. user consent has change to negative consent), then the AMF (or MME) may:
Delete any location information that is saved in the UE context
AMF (or MME) may initiate UE context release with RAN node (e.g. over the N2 interface or S1-AP interface), and optionally include a new cause value e.g., “User Consent Update”, “No User Consent”, or any other suitable cause value, or an existing cause value may be re-used. That is, the network (e.g. AMF) may provide information on user consent to other network entities (e.g. RAN node).
Request other nodes to delete any location information for this UE, or request the SMF (or PGW-C+SMF) to release PDU sessions (or PDN connections) that were established prior to the change in the AMF/MME determination (as described above)
Deregister the UE if the AMF/MME policy requires the UE location to always be used
In any of the above cases, when the AMF (or MME) deregisters the UE or requests a UE to provide location information and/or consent, the AMF (or MME) may use a new cause value in the NAS message (e.g. UE location and/or consent required)
The UE reported TACs and/or selected TAC is determined by the AMF/MME (as described earlier) to correspond to an area/location/country that is not served by this AMF (or this MME), or that corresponds to an area/location/country that should be served by another AMF/MME (optionally in another country/area/location). When this happens, the AMF (or MME) may determine to reject the UE's NAS message using any of the methods proposed above for the case when the AMF (or MME) rejects the UE's NAS message based on any of the above reasons to reject a NAS message

The AMF (or MME) may determine, based on any of the above, that it cannot/should not serve the UE based on e.g. UE reported location information, UE selected TAC, or any combination of the previous information that the UE was proposed to send, and optionally other local AMF/MME policies. When this occurs, the AMF (or MME) may take the following actions:
The AMF (or MME) need not reject the NAS message
The AMF (or MME) sends the NAS message to the RAN and requests the RAN to re-route the NAS message to another AMF (or another MME) in another location
While doing so, the AMF (or MME) may indicate the target location/country of the AMF (or MME) where the NAS message should be re-routed to by the RAN. The AMF (or MME) may determine this information based on the information received in the NAS message from the UE and optionally based on the mapping information that the AMF/MME has (or any other information as described earlier) which is used to determine the country/location/area that the UE is truly in and hence the country/area/location of the AMF (or MME) that should be serving the UE
The AMF (or MME) may include this information in the N2 REROUTE NAS REQUEST message (or S1-AP Reroute NAS Request message) that is sent to the RAN, optionally the AMF (or MME) includes a target AMF ID (MME ID, or MME group ID, etc) where this is determined locally in the AMF (or MME) based on a mapping of e.g. UE location and/or selected TAC to target AMF ID (or target AMF country/area/location)/target MME ID (or target MME country/area/location).
Upon reception of a re-route request by the RAN (optionally received from an AMF over the N2 message/protocol, or from an MME over the S1-AP message/protocol), where optionally the message also contains a target country/location/area and/or UE reported TACs and/or UE selected TAC, the RAN should forward the NAS message to an appropriate/target AMF (or appropriate/target MME). The RAN determines the target AMF (or MME) based on the received target AMF ID/MME ID and/or target AMF country/area/location (or MME country/area/location) or selected TAC. In the case of a selected TAC, the RAN should use local information/configuration to determine the target AMF/MME based on this selected TAC, where the RAN may be preconfigured with such location information/mapping, etc. The RAN may determine the UE location based on the location information that is received from the AMF/MME. The RAN may determine a target AMF (or MME) based on the determined UE location as described herein. The RAN then re-routes or forwards the NAS message (which is received from the CN i.e. AMF (or MME)) to the determined CN node i.e. AMF (or MME).
When forwarding the NAS message to a target AMF (or target MME), the RAN may also include the UE selected TAC and/or determined target area/country/location (that was determined as described above).
The AMF (or MME) may also forward a user consent (e.g. NTN specific user consent) to the RAN where this indicates whether or not the UE location can be acquired and/or can be used by the RAN. The RAN may receive a user consent from the AMF (or MME) (or an indication about whether the UE location can be acquired or used), where the RAN may then determine to acquire/use the UE location as described herein if the consent/indication has a value such indicating that the UE location can indeed be acquired/used.
If the RAN receives a user consent indication that the RAN should not acquire and/or use the UE location information, then the RAN should, e.g., release the UE. The RAN may also send UE context release request to the CN node AMF (or MME) to release the UE. The RAN may include an appropriate cause value (e.g. “No User Consent”, “No NTN User Consent”, or any other suitable cause name).

Note that all the proposals above could be used in any order and combinations.

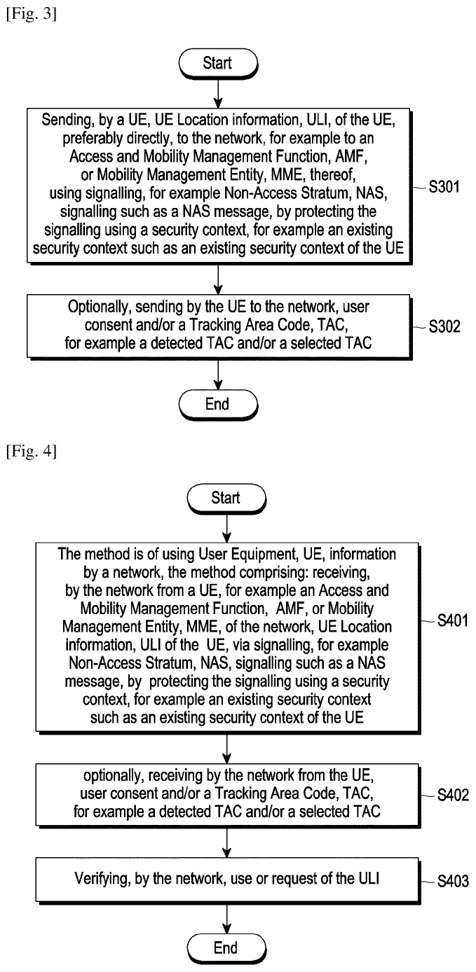

FIG. 3 schematically depicts a method according to an exemplary embodiment.

The method is of sending User Equipment, UE, information in and/or to a network, the method comprising:
sending, by a UE, UE Location Information, ULI, of the UE, preferably directly, to the network, for example to an Access and Mobility Management Function, AMF, or Mobility Management Entity, MME, thereof, using signaling, for example Non-Access Stratum, NAS, signaling such as a NAS message, by protecting the signaling using a security context, for example an existing security context such as an existing security context of the UE (S301); and/or
optionally, sending by the UE to the network, user consent and/or a Tracking Area Code, TAC, for example a detected TAC and/or a selected TAC (S302).

The method may include any of the steps described herein, for example with respect to the first aspect and/or the second aspect.

FIG. 4 schematically depicts a method according to an exemplary embodiment.

The method is of using User Equipment, UE, information by a network, the method comprising:
receiving, by the network from a UE, for example an Access and Mobility Management Function, AMF, or Mobility Management Entity, MME, of the network, UE Location Information, ULI of the UE, via signaling, for example Non-Access Stratum, NAS, signaling such as a NAS message, by protecting the signaling using a security context, for example an existing security context such as an existing security context of the UE (S401);
optionally, receiving by the network from the UE, user consent and/or a Tracking Area Code, TAC, for example a detected TAC and/or a selected TAC (S402); and
verifying, by the network, use or request of the ULI (S403).

The method may include any of the steps described herein, for example with respect to the first aspect and/or the second aspect.

FIG. 5 schematically depicts a method of a network device according to an exemplary embodiment.

The network device may be a device operating in a network side. The network device may be a device implementing a base station, the AMF or the MME.

The network device may perform the method described in FIG. 5 for receiving information from the UE in the NTN.

The network device may identify whether user consent for requesting location information of the UE is required (S501).

Based on identifying that the user consent is required, the network device may identify whether the user consent exists (S502).

Based on identifying that the user consent exists, The network device may transmit a request for the location information of the UE, to the UE (S503).

The network device may receive the location information of the UE from the UE in response to the request.

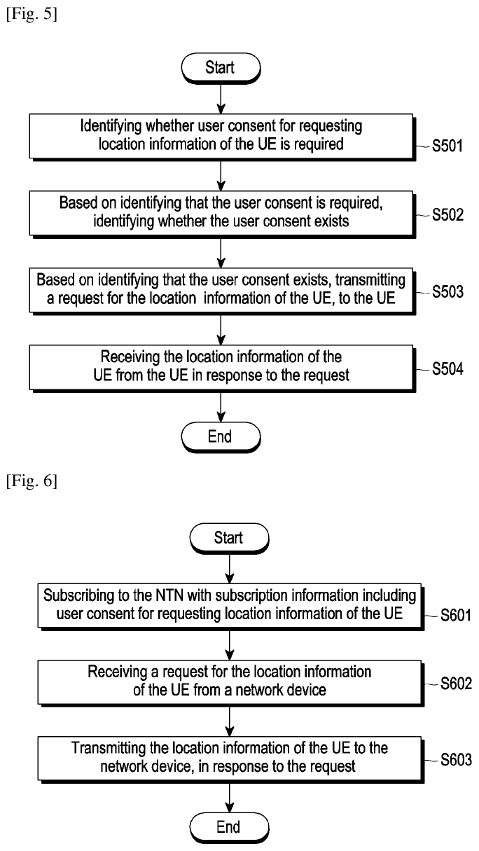

FIG. 6 schematically depicts a method of a UE according to an exemplary embodiment.

The UE may perform the method described in FIG. 6 for transmitting information in the NTN.

The UE may subscribe to the NTN with subscription information including user consent for requesting location information of the UE (S601).

The UE may receive a request for the location information of the UE from a network device (S602).

The UE may transmit the location information of the UE to the network device, in response to the request (S603)

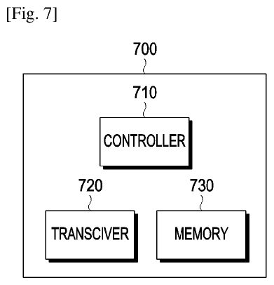

FIG. 7 schematically depicts a block diagram of a device according to an exemplary embodiment.

The device (700) may be the UE described related to FIG. 5, or the network device described related to FIG. 6.

The device (700) may comprise a controller (710), a transceiver (720) and a memory (730).

The controller (710) may be implemented as at least one processor. The controller (710) may be coupled to other components (for example, the transceiver (720) and the memory (730)) of the device (700). The controller (710) may operated to perform operations of the device (700) described herein. The controller (710) may cause the device (700) to perform operations described herein.

The transceiver (720) may be configured as communication circuitry. The device (700) may communicate with other entity through the transceiver (720). The transceiver may support various radio access technologies including, but not limited to, CDMA, LTE, LTE-A, Bluetooth, OFDM, or NFC.

The memory (730) may store temporary data or non-temporary data for operations of the device (700) or the controller (710). The memory may store instructions. When the instructions are executed by the controller (710), the instruction may cause the controller (710) or the device (700) to perform operations described herein.

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method for receiving information from a user equipment (UE) by a network device in a non-terrestrial network (NTN), the method comprising:
identifying whether user consent for requesting location information of the UE is required;
based on identifying that the user consent is required, identifying whether the user consent exists;
based on identifying that the user consent exists, transmitting a request for the location information of the UE, to the UE; and
receiving the location information of the UE from the UE in response to the request.

2. The method of claim 1, wherein whether the user consent is required is identified based on a region to which the UE belongs ;.

3. The method of claim 1, wherein whether the user consent exists is identified based on subscription information of the UE for the NTN.

4. The method of claim 1, wherein the location information of the UE is received through a non-access stratum (NAS) message.

5. The method of claim 4, wherein the NAS message is protected using a security context.

6. The method of claim 5, wherein the security context is one of an activated security context, in use security context, and an existing context of the UE.

7. The method of claim 1, wherein if the UE does not have an existing security context, the location information of the UE is received through a Security Mode Complete message to which ciphering and integrity protection are applied.

8. A method for transmitting information by a user equipment (UE) in a non-terrestrial network (NTN), the method comprising:
subscribing to the NTN with subscription information including user consent for requesting location information of the UE;
receiving a request for the location information of the UE from a network device; and
transmitting the location information of the UE to the network device, in response to the request.

9. The method of claim 8, wherein the location information of the UE is transmitted through a non-access stratum (NAS) message.

10. The method of claim 9, wherein the NAS message is protected using a security context.

11. The method of claim 10, wherein the security context is one of an activated security context, in use security context, and an existing context of the UE.

12. The method of claim 8, wherein if the UE does not have an existing security context, the location information of the UE is transmitted through a Security Mode Complete message to which ciphering and integrity protection are applied.

13. A network device for receiving information from a user equipment (UE) in a non-terrestrial network (NTN), the network device comprising:
a transceiver; and
a controller coupled to the transceiver, wherein the controller is configured to:
identify whether user consent for requesting location information of the UE is required;
based on identifying that the user consent is required, identify whether the user consent exists;
based on identifying that the user consent exists, transmit a request for the location information of the UE, to the UE; and
receive the location information of the UE from the UE in response to the request.

14. (canceled)

15. The network device of claim 13, wherein whether the user consent is required is identified based on a region to which the UE belongs.

16. The network device of claim 13, wherein whether the user consent exists is identified based on subscription information of the UE for the NTN.

17. The network device of claim 13, wherein the location information of the UE is received through a non-access stratum (NAS) message.

18. The network device of claim 17, wherein the NAS message is protected using a security context.

19. The network device of claim 18, wherein the security context is one of an activated security context, in use security context, and an existing context of the UE.

20. The network device of claim 1, wherein if the UE does not have an existing security context, the location information of the UE is received through a Security Mode Complete message to which ciphering and integrity protection are applied.
